(19) United States
(12) Patent Application Publication
(10) Pub. No.: US 2018/0300330 A1
(43) Pub. Date: Oct. 18, 2018

(54) PROACTIVE SPILLING OF PROBE RECORDS IN HYBRID HASH JOIN

(71) Applicant: Google Inc., Mountain View, CA (US)

(72) Inventor: Bart Samwel, Oegstgeest (NL)

(73) Assignee: Google Inc., Mountain View, CA (US)

(21) Appl. No.: 15/681,264

(22) Filed: Aug. 18, 2017

(30) Foreign Application Priority Data
Apr. 18, 2017 (NL) 2018726

(51) Int. Cl. G06F 17/30

(52) U.S. Cl. CPC G06F 17/3033; G06F 17/30466

(57) ABSTRACT

Described is an efficient hybrid hash join using proactive spilling of probe records to a probe-side data structure. A computing system creates a hash index representative of a portion of a first dataset (build input) and spills the remaining portion of the first dataset to a data structure based on partitioning groups. In parallel, the computing system processes a second dataset (probe input) to populate a probe-side data structure based on the same partitioning. The computing system can probe the hash index and search the build-side spill-over data structure for entries from the second dataset in parallel with populating the probe-side data structure.

### CROSS-REFERENCES TO RELATED APPLICATIONS

This application claims the benefit of priority to the Netherlands Patent Application No. 2018726 filed on Apr. 18, 2017, which is incorporated herein by reference in its entirety.

### BACKGROUND

Join functions are used to identify record correlations across multiple sets of records. Generally, records have a correlation when particular elements of the records match. A hash join generates a hash value for each of the particular elements (or groups of elements) and uses the hash values to identify correlations. In some instances, where it's possible for distinct different elements to share the same hash value, an implementation may identify entries with the same hash values and then further analyze the entries, comparing the particular element values, to confirm the correlations.

### SUMMARY

Systems and methods are described for an efficient hybrid hash join using proactive spilling of probe records to a data structure. A computing system creates a hash index representative of a portion of a first dataset (build input) and spills the remaining portion of the first dataset to a build-side data structure based on partitioning groups. In parallel, the computing system processes a second dataset (probe input) to populate a probe-side data structure based on the same partitioning. The computing system then probes the hash index and accesses the build-side spill-over data structure to identify entries matching to the probe input. In some implementations, the system distributes information from the data structures for parallel processing. Data for each partitioning group from the build-side spill-over data structure and from the corresponding probe-side data structure can be matched in parallel with the other partitioning groups. In some implementations, the matching is a recursive join on each partitioning group. These and other features are described in more detail herein.

In at least one aspect, described is a method of processing a join instruction on a first dataset and a second dataset, the method including processing the first dataset by a computing system comprising one or more processors with access to a first memory and with access to a second memory, using a partitioning function that deterministically partitions records into respective ones of a plurality of groups. The computing system processes the first dataset by building, in the first memory, a hash index representative of the first dataset using a first subset of records from the first dataset; determining that the hash index utilizes a threshold allocation of the first memory and, in response, moving records fitting into a first group defined by the partitioning function from the hash index in the first memory to a data structure in the second memory; adding entries to the hash index in the first memory using a second subset of records from the first dataset, the second subset of records fitting into a second group defined by the partitioning function, wherein the second subset of records excludes a third subset of records from the first dataset fitting into the first group defined by the partitioning function; and recording, in the data structure in the second memory, the third subset of records from the first dataset. The method further includes processing, by the computing system in parallel with processing the first dataset, a first portion of the second dataset by recording, in the second memory, records from the first portion of the second dataset partitioned by the computing system into a plurality of groups in accordance with the partitioning function. The method further includes determining, by the computing system, that all records of the first dataset are represented in one of either the hash index or the data structure, and in response, (i) probing the hash index for records matching records in a second portion of the second dataset fitting into the second group defined by the partitioning function and (ii) probing the data structure for records matching records in the second dataset fitting into the first group defined by the partitioning function.

In at least one aspect, described is a non-transitory computer-readable medium storing instructions that cause a processor executing the instructions to processes a first dataset, using a partitioning function that deterministically partitions records into respective ones of a plurality of groups, by: building, in a first memory, a hash index representative of the first dataset using a first subset of records from the first dataset; determining that the hash index utilizes a threshold allocation of the first memory and, in response, moving records fitting into a first group defined by the partitioning function from the hash index in the first memory to a data structure in a second memory; adding entries to the hash index in the first memory using a second subset of records from the first dataset, the second subset of records fitting into a second group defined by the partitioning function, wherein the second subset of records excludes a third subset of records from the first dataset fitting into the first group defined by the partitioning function; and recording, in the data structure in the second memory, the third subset of records from the first dataset. The instructions further cause executing processors to process a first portion of a second dataset in parallel with processing the first dataset by recording, in the second memory, records from the first portion of the second dataset partitioned by the computing system into a plurality of groups in accordance with the partitioning function. The instructions further cause executing processors to determine when all records of the first dataset are represented in one of either the hash index or the data structure, and in response, (i) probe the hash index for records matching records in a second portion of the second dataset fitting into the second group defined by the partitioning function and (ii) identify records from the data structure matching records in the second dataset fitting into the first group defined by the partitioning function.

In at least one aspect, described is a system that includes one or more processors each with access to a first memory and with access to a second memory, the one or more processors configured to execute instructions to processes a first dataset, using a partitioning function that deterministically partitions records into respective ones of a plurality of groups, by: building, in a first memory, a hash index representative of the first dataset using a first subset of records from the first dataset; determining that the hash index utilizes a threshold allocation of the first memory and, in response, moving records fitting into a first group defined by the partitioning function from the hash index in the first memory to a data structure in a second memory; adding entries to the hash index in the first memory using a second subset of records from the first dataset, the second subset of records fitting into a second group defined by the partitioning function, wherein the second subset of records excludes a third subset of records from the first dataset fitting into the first group defined by the partitioning function; and recording, in the data structure in the second memory, the third subset of records from the first dataset. The instructions further cause executing processors to process a first portion of a second dataset in parallel with processing the first dataset by recording, in the second memory, records from the first portion of the second dataset partitioned by the computing system into a plurality of groups in accordance with the partitioning function. The instructions further cause executing processors to determine when all records of the first dataset are represented in one of either the hash index or the data structure, and in response, (i) probe the hash index for records matching records in a second portion of the second dataset fitting into the second group defined by the partitioning function and (ii) identify records from the data structure matching records in the second dataset fitting into the first group defined by the partitioning function.

Following below are more detailed descriptions of various concepts related to, and implementations of, methods, apparatuses, and systems relating to hash joins. The various concepts introduced above and discussed in greater detail below may be implemented in any of numerous ways, as the described concepts are not limited to any particular manner of implementation.

### BRIEF DESCRIPTION OF THE DRAWINGS

The above and related objects, features, and advantages of the present disclosure will be more fully understood by reference to the following detailed description, when taken in conjunction with the accompanying figures, wherein:

FIG. 1 is a block diagram illustrating an example computing device suitable for use in the various implementations described herein;

FIG. 2 is a flowchart for an example method of an efficient hybrid hash join using proactive spilling of probe records to a data structure;

FIG. 3 is a flowchart for an example method of preparing a first dataset for efficient comparison;

FIG. 4 is a flowchart for an example method of preparing a second dataset for efficient comparison to the first dataset;

FIG. 5 is a flowchart for an example method of transitioning from a build phase to a probe phase; and

FIG. 6 is a flowchart for an example method of comparing the second dataset to the first dataset.

For purposes of clarity, not every component may be labeled in every figure. The drawings are not intended to be drawn to scale. Like reference numbers and designations in the various figures indicate like elements.

### DETAILED DESCRIPTION

Described herein are various implementations of a hash join with proactive spilling of probe records. Join functions are used to identify record correlations across multiple sets of records. Generally, records have a correlation when particular elements of the records match. A hash join generates a hash value for each of these particular elements and uses the hash value to identify possible correlations, which may then be confirmed by comparing the elements. Although generating the hash values adds complexity, certain data structures built around the hash values significantly reduce the computational complexity of identifying the correlations. This reduced complexity allows for significantly faster join operations that scale well with large datasets.

As a brief high-level overview of a hash join, a computing system generates a data structure in memory from one of two sets of data to be joined, and probes the in-memory data structure to identify entries corresponding to records from the other of the two sets of data. The data structure acts an index and is sometimes called a hash index or hash table. It is referred to herein as a “hash index” without limitation to any one particular data structure implementation, i.e., it may be implemented as an array, table, map, or any other suitable data structure.

The dataset used to build the hash index is referred to as the “build input.” In some implementations, when the computing system has size information for the two sets of data to be joined, the computing system selects the smaller of the two datasets as the build input. For each record in the build input, the computing system uses a hashing function applied to one or more elements of the record to generate a hash value (sometimes called a “digest”), and creates an entry in the hash index at a location that can be identified efficiently from the hash value, e.g., identified in a fixed number of steps regardless of the size of the hash index (i.e., in constant time). The entry may be, for example, a value or set of values corresponding to the record or, as another example, an address back to the source dataset for the build input. In some implementations, the entry may include a copy of, or portions of, the record from the source dataset. Hash functions have a limited number of possible outputs (called the “digest space”) and will occasionally generate collisions in which two distinct inputs result in the same hash value output. However, techniques exist to deal with those collisions. For example, the hash index may be structured such that the location identified efficiently from the hash value is a container for one or more entries, e.g., a linked list of all entries corresponding to the hash value.

The computing system probes the hash index to determine if a record in the other dataset, referred to as the “probe input,” corresponds to anything in the build input. To probe the hash index for a record, the computing system uses the same hashing function to generate a hash value for the probe record and checks the location in the hash index corresponding to the generated hash value. Because this check can be performed in constant time (plus the marginal time required to search a collision-resolution structure), the check is significantly more computationally efficient than having to search the entire build input for each probe input record.

The computing system can use any deterministic hashing function to generate the hash values, including, but not limited to, MurmurHash, SipHash, DJB2, MD5, SHA, Pearson hashing, and variations thereof. Hash functions have a variety of characteristics, including computational complexity, function speed, available hardware implementations, difficulty of inversion (cryptographic hash functions like MD5 or SHA are designed to make it difficult or near impracticable to generate an input that will result in a pre-selected hash value), size of the digest space (i.e., the number of possible hash values or digests), probability of collisions, and distribution of collisions across the digest space for a given class or type of input (referred to as uniformity). In some implementations, a hash function is selected to emphasize one or more of these characteristics over the others. In some implementations, a hash function is selected based on the type of data to be hashed.

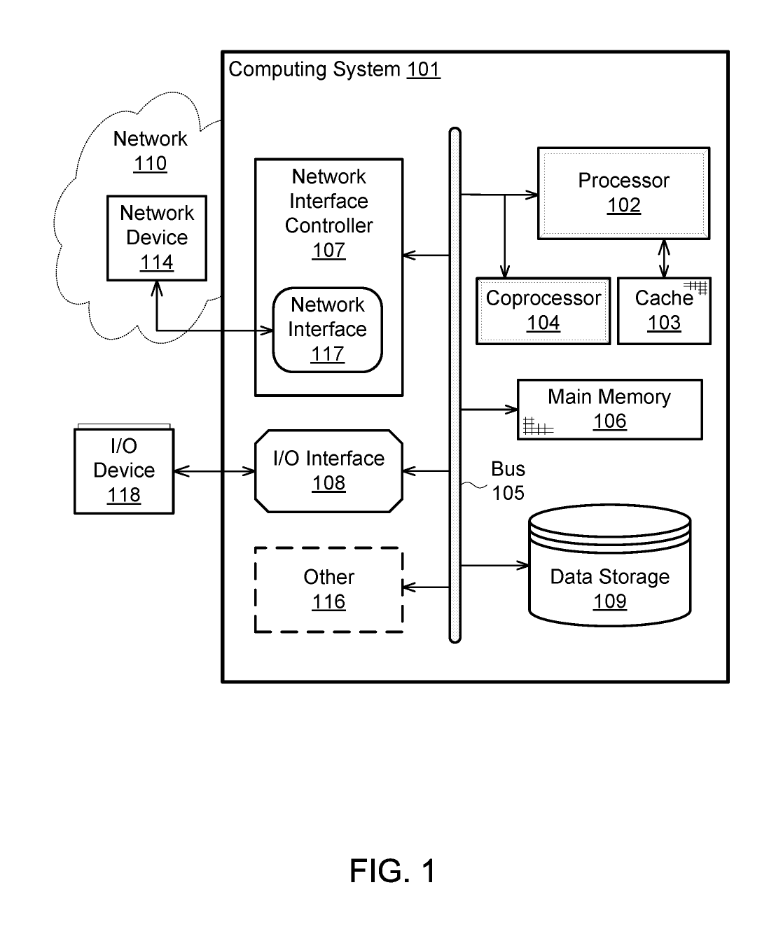

FIG. 1 is a block diagram of an example computing system 101. The example computing system 101 is suitable for use in implementing the computerized components described herein, in accordance with an illustrative implementation. In broad overview, the computing system 101 includes a processor 102 for performing actions in accordance with instructions, e.g., instructions held in cache memory 103. The illustrated example computing system 101 includes one or more processors 102 and coprocessors 104 in communication, via a bus 105, with main memory 106, a network interface controller 107, an input/output (“I/O”) interface 108, and a data storage 109. In some implementations, the computing system 101 may include additional interfaces or other components 116. Generally, a processor 102 will load instructions from main memory 106 (or from data storage 109) into cache memory 103, load instructions from cache memory 103 into onboard registers, and execute instructions from the onboard registers. In some implementations, instructions are encoded in and read from a read-only memory (“ROM”) or from a firmware memory chip (e.g., storing instructions for a Basic Input/Output System (“BIOS”)), not shown. As shown, the processor 102 is directly connected to the cache memory 103; however, in some implementations, the cache memory 103 is integrated into the processor 102 or implemented on the same circuit or chip as the processor 102. Some implementations include multiple layers or levels of cache memory 103, each further removed from the processor 102. Some implementations include multiple processors 102 and/or coprocessors 104 that augment the processor 102 with support for additional specialized instructions (e.g., a math coprocessor, a floating point coprocessor, and/or a graphics coprocessor). As shown, the coprocessor 104 is closely connected to the processor 102; however, in some implementations, the coprocessor 104 is integrated into the processor 102 or implemented on the same circuit or chip as the processor 102. In some implementations, the coprocessor 104 is further removed from the processor 102, e.g., connected to the bus 105. The network interface controller 107 controls one or more network interfaces 117 for connection to network devices 114 (e.g., for access to a network 110). The I/O interface 108 facilitates sending and receiving data to various I/O devices 118 such as, but not limited to, keyboards, touch screens, microphones, motion sensors, video displays, speakers, haptic feedback devices, printers, and so forth. In some implementations, one or more of the I/O devices 118 are integrated into the computing system 101. In some implementations, one or more of the I/O devices 118 are external to, and separable from, the computing system 101. In some implementations, the computing system 101 is implemented using special purpose logic circuitry, e.g., an application-specific integrated circuit (“ASIC”) or a system on a chip (“Sort”) semiconductor device that includes the processor 102 and one or more additional components, e.g., the cache memory 103, network interface controller 107 and network interface 117, and one or more I/O interfaces 108.

In more detail, the processors 102 may be any logic circuitry that processes instructions, e.g., instructions fetched from the cache memory 103, main memory 106, data storage 109, or other memory not shown. The processor 102 includes a number of data and instruction registers. In some implementations, on start-up (“boot”), the processor 102 loads initial instructions from a BIOS into the registers, including instructions for loading more instructions, and executes instructions from the registers. In some implementations, the BIOS instructions cause the processor 102 to load an operating system (“OS”), which in turn causes the processor 102 to load and execute one or more programs. The processors 102 may be augmented by one or more ancillary coprocessors 104, which are auxiliary processing units with specialized instruction sets for specific purposes. In some implementations, a processor 102 faced with an unrecognized instruction will pass the instruction to a coprocessor 104, e.g., via a special bus, and only generate an un-recognized instruction fault if the coprocessor 104 also does not recognize the instruction. The processors 102 and coprocessors 104 may each be single core or multi-core processor(s). The computing system 101 may include multiple distinct processors 102 and/or multiple distinct coprocessors 104. For example, in some implementations, a general purpose processor 102 such as a multi-core central processing unit (“CPU”) may be augmented with one or more special purpose coprocessors 104, such as a math coprocessor, floating point coprocessor, or a graphics processing unit (“GPU”). For example, a math coprocessor 104 can assist the processor 102 with high precision or complex calculations. In some implementations, the processor(s) 102 and coprocessors 104 are implemented as circuitry on one or more “chips.” The computing system 101 may be based on any processor 102, or set of processors 102 and/or coprocessors 104, capable of operating as described herein.

The cache memory 103 is generally a form of computer memory placed in close proximity to a processor 102 for fast access times. In some implementations, the cache memory 103 is memory circuitry that is part of, or on the same chip as, a processor 102. In some implementations, there are multiple levels of cache memory 103, e.g., L2 and L3 cache layers. In some implementations, multiple processors 102, and/or multiple cores of a processor 102, share access to the same cache memory 103.

The main memory 106 may be any device suitable for storing computer readable data. The main memory 106 is a device that supports direct access to specified addresses; i.e., the main memory 106 is random access memory (“RAM”). In some implementations, the main memory 106 is a volatile semiconductor memory device such as dynamic random-access memory (“DRAM”), synchronous dynamic random-access memory (“SDRAM”), double data rate SDRAM (“DDR SDRAM”), static random-access memory (“SRAM”), T-RAM, Z-RAM, and so forth. A computing system 101 may have any number of devices serving as main memory 106.

The data storage 109 may be any device suitable for storing computer readable data between power cycles. In some implementations, the data storage 109 is a device with fixed storage media, such as magnetic disks, e.g., a hard disk drive (“HDD”). In some implementations, the data storage 109 is a device with removable storage media, such as magnetic disks (e.g., a floppy disk drive or removable HDD), magnetic tape, magneto-optical disks, or optical discs (e.g., CD ROM, DVD-ROM, or BLU-RAY discs). In some implementations, the data storage 109 is a non-volatile semiconductor memory device such as an erasable programmable read-only memory (“EPROM”), electrically erasable programmable read-only memory (“EPROM”), or Flash memory. In some implementations, the main memory 106 is a solid-state drive (“SSD”), e.g., using multi-level cell (“MLC”) NAND-based Flash memory. A computing system 101 may have any number of devices serving as data storage 109.

The registers on the processor 102, the cache memory 103, the main memory 106, and the data storage 109 each have different associated access speeds and storage capacities. In general, the registers on the processor 102 have the fastest access speed, followed by the different levels of cache memory 103, then the main memory 106, and the data storage 109 has the slowest access speed (compared to the cache memory 103 and main memory 106). In some implementations, the I/O interface 108 or other components 116 may connect to or include even slower memory devices such as external disk drives, media readers, and portable Flash devices. Likewise, in general, the registers on the processor 102 have the smallest capacity, followed by the different levels of cache memory 103, then the main memory 106, and the data storage 109 has the largest capacity (compared to the cache memory 103 and main memory 106). In some implementations, the network interface 117 may be connected, via the network 110, to a network device 114 that provides network-based storage. Access to network-based storage is limited by the network and may therefore, in some instances, be even slower than the locally attached or incorporated storage and memory devices. However, the network-based storage may have extensive capacity, and may in some implementations be considered effectively inexhaustible. In some instances, external network-based storage may be just as fast as local storage using similar hardware because the network may have sufficient bandwidth to not be a bottleneck compared to the storage hardware itself. Furthermore, network-based storage may be distributed over multiple physical devices, and have the appearance of inexhaustible write and read bandwidth.

The difference in access time between main memory 106 and the slower devices such as data storage 109 or network-based storage may be an order of magnitude or more. Some memory devices used for main memory 106 are ten, twenty, or thirty times faster than HDD or SSD devices used for data storage 109. For example, as an approximation, some current implementations of cache memory 103 have an access speed of roughly one hundred gigabytes per second, some implementations of main memory 106 have an access speed of roughly ten gigabytes per second, and some implementations of data storage 109 have an access speed of less than one gigabyte per second. However, the capacity of the cache memory 103 and main memory 106 is limited and the hash index may exceed the available capacity of the faster memory devices. Accordingly, as described in more detail herein, in some instances, a hash join uses a hash index (or portions of the hash index) held in a faster memory with limited capacity, e.g., the main memory 106, and a spill-over data structure held in slower memory with greater capacity, e.g., the data storage 109.

Still referring to FIG. 1, the bus 105 is an interface that provides for data exchange between the various internal components of the computing system 101, e.g., connecting the processor 102 to the main memory 106, the network interface controller 107, the I/O interface 108, and data storage 109. In some implementations, the bus 105 further provides for data exchange with one or more components external to the computing system 101, e.g., other components 116. In some implementations, the bus 105 includes serial and/or parallel communication links. In some implementations, the bus 105 implements a data bus standard such as integrated drive electronics (“IDE”), peripheral component interconnect express (“PCP”), small computer system interface (“SCSI”), or universal serial bus (“USB”). In some implementations, the computing system 101 has multiple busses 105.

The computing system 101 may include, or provide interfaces 108 for, one or more input or output (“I/O”) devices 118. Input devices include, without limitation, keyboards, touch screens, touchpads (e.g., electromagnetic induction pads, electrostatic pads, capacitive pads, etc.), microphones, joysticks, foot pedals, inertial measurement units (“IMU”), accelerometers, gyroscopes, tilt-sensors, motion sensors, environmental sensors, Musical Instrument Digital Interface (“MIDI”) input devices such as MIDI instruments (e.g., MIDI keyboards), styluses, and pointing devices such as a mouse or trackball. Output devices include, without limitation, video displays, speakers, haptic feedback devices, refreshable Braille terminals, lights, servos, MIDI output devices such as MIDI synthesizers, and two or three dimensional printers (including, but not limited to, inkjet printers, laser printers, thermographic printers, stereolithographic printers, extrusion deposition printers, and metal sintering printers).

The network 110 enables communication between various nodes such as the computing system 101 and a network device 114. In some implementations, data flows through the network 110 from a source node to a destination node as a flow of data packets, e.g., in the form of data packets in accordance with the Open Systems Interconnection (“OSI”) layers. A flow of packets may use, for example, an OSI layer-4 transport protocol such as the User Datagram Protocol (“UDP”), the Transmission Control Protocol (“TCP”), or the Stream Control Transmission Protocol (“SCTP”), transmitted via the network 110 layered over an OSI layer-3 network protocol such as Internet Protocol (“IP”), e.g., IPv4 or IPv6. The network 110 is composed of various network devices (“nodes”) linked together to form one or more data communication paths between participating devices. Each networked device includes at least one network interface for receiving and/or transmitting data, typically as one or more data packets. An illustrative network 110 is the Internet; however, other networks may be used. The network 110 may be an autonomous system (“AS”), i.e., a network that is operated under a consistent unified routing policy (or at least appears to from outside the AS network) and is generally managed by a single administrative entity (e.g., a system operator, administrator, or administrative group). The network 110 may be composed of multiple connected sub-networks or AS networks, which may meet at one or more of: an intervening network (a “transit network”), a dual-homed gateway node, a point of presence (“POP”), an Internet eXchange Point (“IXP”), and/or additional other network boundaries. The network 110 can be a local-area network (“LAN”) such as a company intranet, a metropolitan area network (“MAN”), a wide area network (“WAN”), an inter network such as the Internet, or a peer-to-peer network, e.g., an ad hoc Wi-Fi peer-to-peer network. The data links between nodes in the network 110 may be any combination of physical links (e.g., fiber optic, mesh, coaxial, twisted-pair such as Cat-5 or Cat-6, etc.) and/or wireless links (e.g., radio, satellite, microwave, etc.). The network 110 may include carrier networks for mobile communication devices, e.g., networks implementing wireless communication protocols such as the Global System for Mobile Communications (“GSM”), Code Division Multiple Access (“CDMA”), Time Division Synchronous Code Division Multiple Access (“TD-SCDMA”), Long-Term Evolution (“LTE”), or any other such protocol including, but not limited to, so-called generation “3G,” “4G,” and “5G” protocols. The network 110 may include short-range wireless links, e.g., via Wi-Fi, BLUETOOTH, BLE, or ZIGBEE, sometimes referred to as a personal area network (“PAN”) or mesh network. The network may be public, private, or a combination of public and private networks. The network 110 may be any type and/or form of data network and/or communication network.

The network interface controller 107 manages data exchanges with devices in the network 110 (e.g., the network device 114) via the network interface 117 (sometimes referred to as a network interface “port”). The network interface controller 107 handles the physical and data link layers of the Open Systems Interconnection (“OSI”) model for network communication. In some implementations, some of the network interface controller's tasks are handled by the processors 102 and/or coprocessors 104. In some implementations, the network interface controller 107 is incorporated into the processor 102, e.g., as circuitry on the same chip. In some implementations, a computing system 101 has multiple network interfaces 117 controlled by a single controller 107. In some implementations, a computing system 101 has multiple network interface controllers 107. In some implementations, each network interface 117 is a connection point for a physical network link (e.g., a cat-5 Ethernet link). In some implementations, the network interface controller 107 supports wireless network connections and an interface 117 is a wireless (e.g., radio) receiver/transmitter (e.g., for any of the IEEE 802.11 Wi-Fi protocols, near field communication (“NFC”), BLUETOOTH, BLUETOOTH LOW ENERGY (“BLE”), ZIGBEE, ANT, or any other wireless protocol). In some implementations, the network interface controller 107 implements one or more network protocols such as Ethernet. Generally, a computing system 101 exchanges data with other computing devices via physical or wireless links through a network interface 117. The network interface 117 may link directly to another device or to another device via an intermediary device, e.g., a network device 114 such as a hub, a bridge, a switch, or a router, connecting the computing system 101 to the network 110.

The network device 114 may be a hub, switch, router, modem, network bridge, another computing system 101, or any other network node. In some implementations, the network device 114 is a network gateway. In some implementations, the network device 114 is a routing device implemented using customized hardware such as a special purpose processor and/or a ternary content-addressable memory (“TCAM”).

The other components 116 may include an alternative I/O interface, external serial device ports, and any additional coprocessors 104 that are connected via the bus 105. For example, a computing system 101 may include an interface (e.g., a universal serial bus (“USB”) interface) for connecting external input devices, output devices, or additional memory devices (e.g., portable flash drive or external media drive).

The illustrated computing system 101 is suitable for implementing systems that use a hash join, and, in particular, implementations of a hash join with proactive spilling of probe records. For example, in some implementations, the computing system 101 hosts a database.

A database, or more specifically a database management system (“DBMS”), organizes data in accordance with a database definition, e.g., a database schema. For example, in a relational database, the DBMS maintains data in a table-like data structure. Each table has columns, each corresponding to an entry type, classification, or purpose. For example, a table might have a column for numerical data, a column for text data (e.g., a description of the numerical data), a column for date data, and so forth. In some implementations, a column represents structured data grouping multiple data elements into a single column. In a relational database, each entry in a column in a table is also in a row associating the entry with entries from other columns in the table. In some instances, an entry (or combination of entries) will associate a row from one table with one or more rows in another table. In some DBMS implementations, virtual tables called “views” represent data pulled from one or more tables as though it, too, were a table (that is, the view looks to a database client or user as though it was a table, but is not necessarily stored as such). Other types of database management systems can also be used, including various types of relational databases, object oriented databases, document oriented databases, Extensible Markup Language (“XML”) databases, NoSQL databases, and so forth. Many of these database types use tables, or table-like structures, in a manner similar to that described above in reference to relational databases. In some database implementations, data is stored or represented in a manner other than a table, e.g., as a collection of data tuples.

A client or user of a database can add data to, modify data in, or retrieve data from the database using database instructions, e.g., queries in a database query language such as the Structured Query Language (“SQL”). One or more database instructions may be grouped together into a database transaction. Traditionally, a database provides transaction atomicity, consistency, isolation, and durability. These properties are known by the acronym “ACID.” In some implementations, a DBMS provides all of the ACID properties. However, in some implementations, the DBMS does not provide all of the ACID properties.

In some implementations, one or more of clients devices, e.g., instances of the computing device 102, are in communication with the DBMS, e.g., via a direct link or via the network 110. In some implementations, one or more of the clients obtain data from the DBMS using queries in a formal query language such as Structured Query Language (“SQL”), Hyper Text Structured Query Language (“HTSQL”), Contextual Query Language (“CQL”), Data Mining Extensions (“DMX”), or XML Query (“XQuery”). In some implementations, one or more of the clients obtain data from the DBMS using an inter-process communication architecture such as the Common Object Request Broker Architecture (“CORBA”), Remote Procedure Calls (“RPC”), Object Linking and Embedding (“OLE”), Component Object Model (“COM”), or Distributed Component Object Model (“DCOM”). In some implementations, one or more of the clients obtain data from the DBMS using natural language or semantic queries. In some implementations, one or more of the clients obtain data from the DBMS using queries in a custom query language such as a Visualization API Query Language.

Databases can perform various operations on data stored or represented in the database. In particular, databases provide functionality for matching records, e.g., to group records together by common elements, to identify corresponding records across multiple tables or data collections, and to perform various set operations like union, intersection, and merge. Some databases use hash joins to provide some of this functionality. In some implementations, a DBMS implements a hash join in accordance with this description.

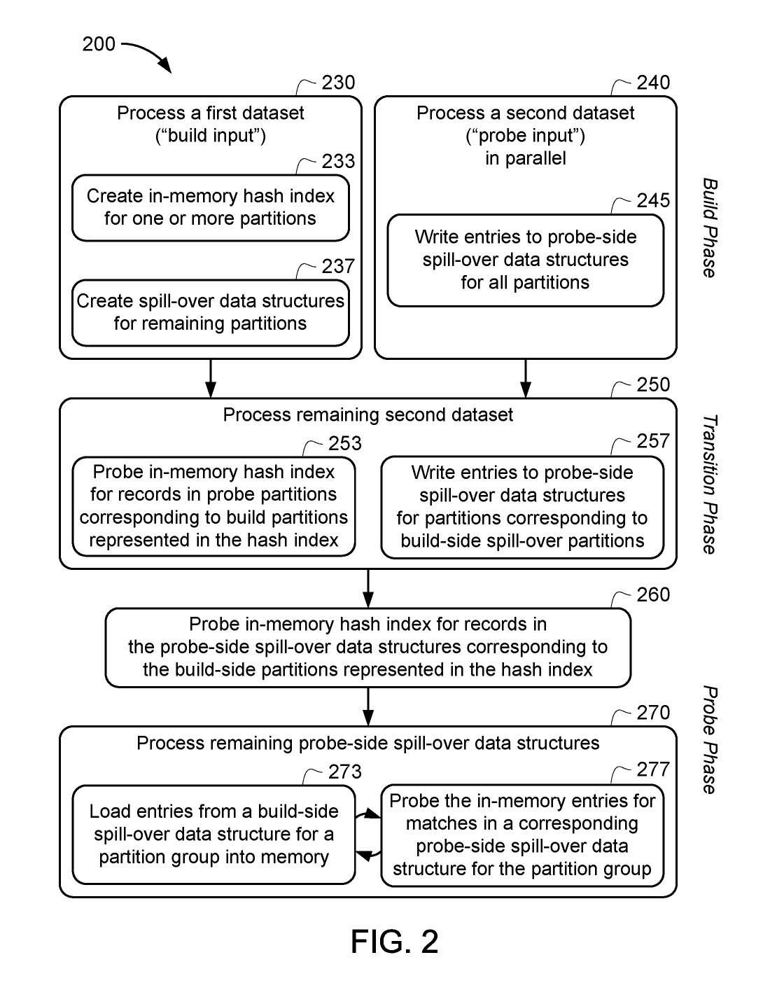

FIG. 2 is a flowchart for an example method 200 of an efficient hybrid hash join using proactive spilling of probe records to a data structure. As introduced above, a hash join prepares a hash index from a build input for efficient comparisons with a probe input. Construction of the hash index takes place in a build phase and the comparisons take place in a probe phase and, in some implementations, during an intermediary transition phase between the build phase and the probe phase.

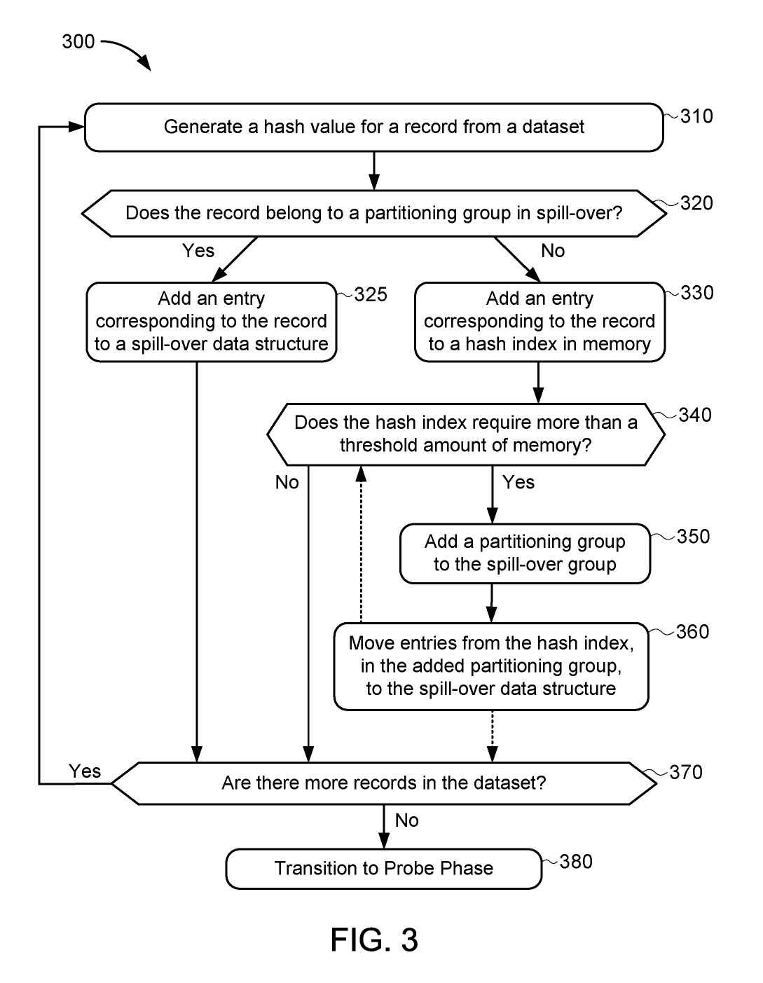

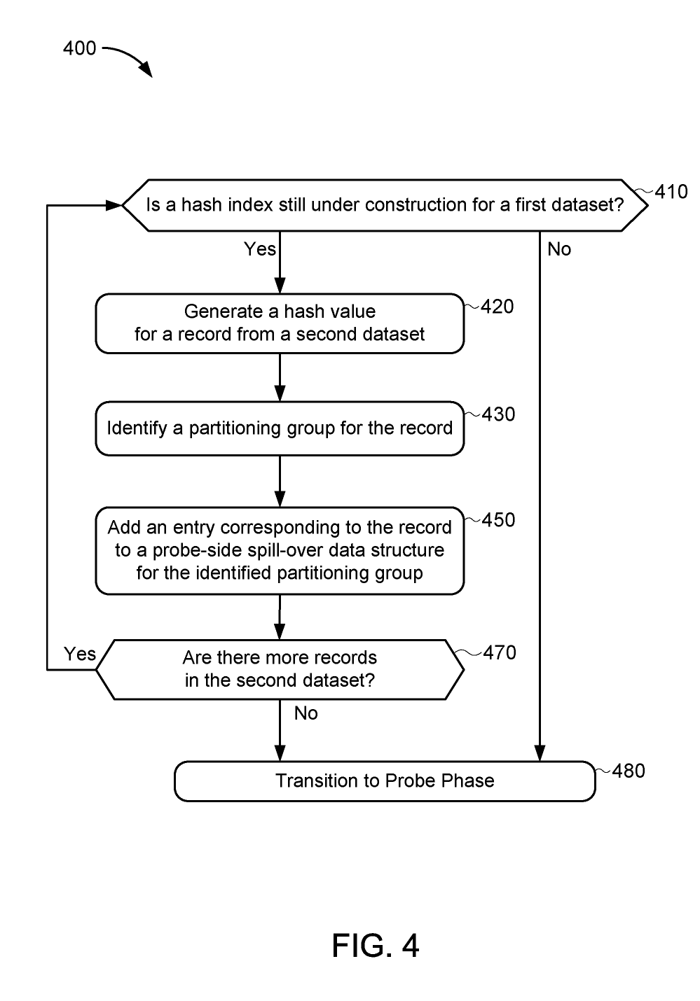

In the method 200, beginning with a build phase, at stage 230, a processor 102 processes a first dataset (a build input) and, in parallel, the processor 102 or another processor 102, at stage 240, processes a second dataset (a probe input). In stage 230, the processor 102, at sub-stage 233, creates an in-memory hash index for one or more partitions of the build input and, at sub-stage 237, creates a spill-over data structure (or data structures) for the remaining partitions of the build input. An example implementation of stages 230, 233, and 237, is described below in reference to FIG. 3. In parallel, at stage 245, the processor 102 writes entries to a probe-side data structure (or data structures) for all partitions of the probe input. The probe-side data structure is similar to the build-side spill-over data structure and, in some implementations, may use the same spill-over data structure format. An example implementation of stages 240 and 245 is described below in reference to FIG. 4.

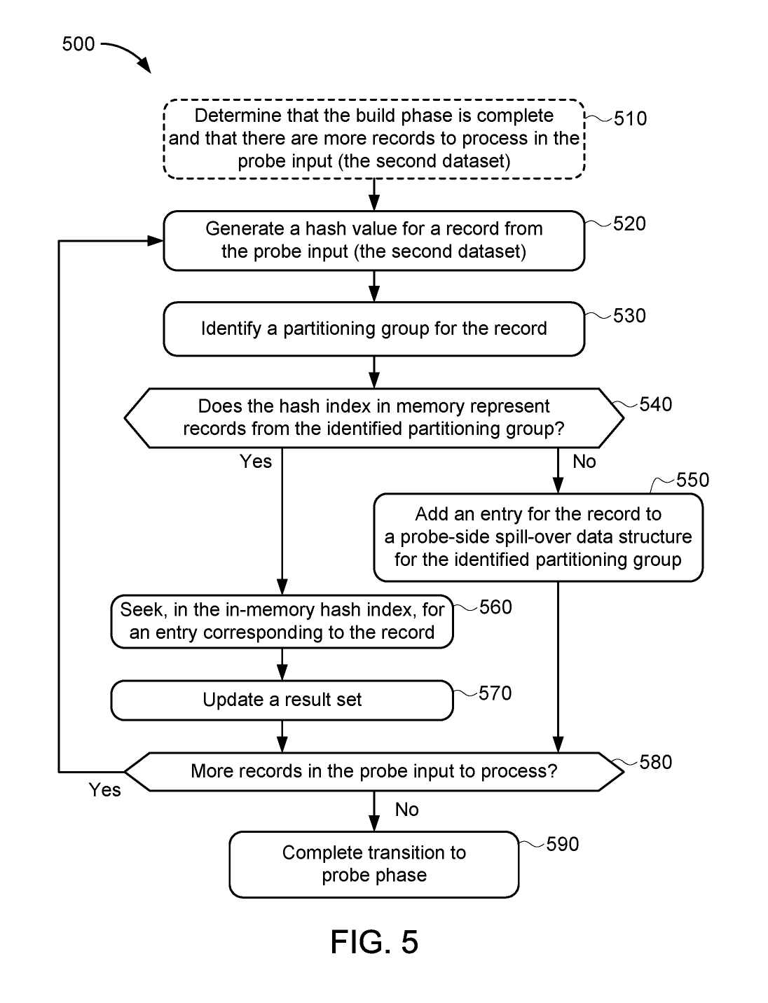

When the processor 102 has completed processing the build input in stage 230, it is possible (and in some implementations, likely) that the processor 102 will not have fully processed the probe input in stage 240. In these situations, after completion of stage 230, the method 200 cleanly wraps up stage 240 and enters a transition phase. At stage 250, the processor 102 processes the remaining records from the second dataset (the probe input), which includes, at sub-stage 253, probing the in-memory hash index for records in probe partitions corresponding to build partitions represented in the hash index and, at sub-stage 257, continuing to write entries to the probe-side spill-over data structures for partitions corresponding to build-side spill-over partitions. That is, if a probe record corresponds to a partition that is not represented in the hash index, the processor 102 creates an entry for the probe record in the same manner described for stage 245. An example implementation of stages 250, 253, and 257 is described below in reference to FIG. 5.

In some instances, the processor 102 processes the entire probe input in stage 240 before finishing stage 230. In such instances, the processor 102 may determine that the probe input has been fully processed when construction of the hash index is complete and, accordingly, skip stage 250.

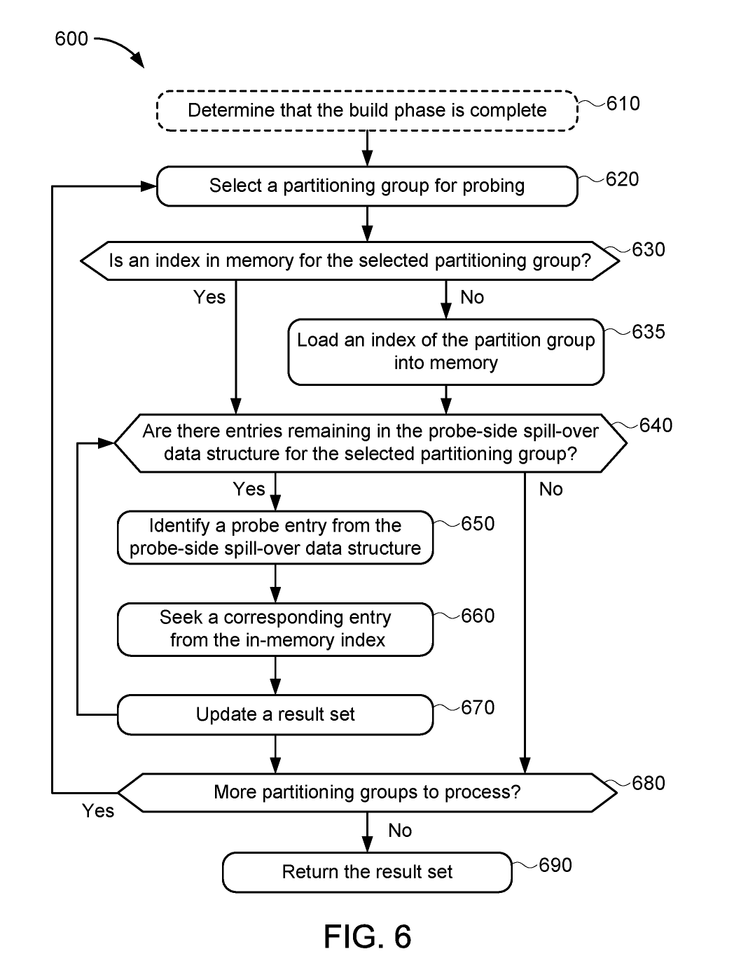

Once the processor 102 has finished the build phase and the transition phase (if not skipped), the processor 102 begins a probe phase. The partitioning effected in stages 233, 237, 245, and 257 facilitates a variety of serial and parallel implementations of the probe phase, which are described in more detail below. In at least one implementation, as shown in FIG. 2, at stage 260, the processor 102 probes the in-memory hash index for records in the probe-side spill-over data structures corresponding to the build-side partitions represented in the hash index. Then, when all probe records that could be matched to the hash index have been matched, the processor 102 can free the memory used by the hash index. At stage 270, the processor 102 processes the remaining records from the probe-side spill-over data structures. Because stage 270 does not use the hash index, it can be implemented by another processor 102 in parallel with stage 260. In some implementations, the processor 102 implements stage 270 by joining build-side and probe-side spill-over data structures for the same partition groups. The union of the results of these joins is included in the result of the hash join. The joins may be recursive invocations of the hash join itself Alternatively, in a serial implementation, at stage 273, the processor 102 loads entries from a build-side spill-over data structure for a partitioning group into memory and, at stage 277, probes the in-memory entries for matches in a corresponding probe-side spill-over data structure for the partition group. The processor 102 repeats stages 273 and 277 until it has processed all partitioning group records. In some implementations, at stage 273, the processor 102 identifies the smaller of the build-side spill-over data structure and the probe-side spill-over data structure for a particular partition group, and loads the identified smaller data structure into memory; the processor 102 then, at stage 277, probes the in-memory entries for matches in the remaining data structure of the two. This optimization may result in loading the probe-side data structure into memory and probing it from the build-side spill-over data structure. This role swap doesn't change the result, it just reduces the amount of data loaded into memory at stage 273. In some implementations, the data to be loaded into memory at stage 273 may exceed the available capacity of the memory. If the data can't be loaded, the processor 102 divides it into sub-partitions. Recursive use of the method 200 achieves this automatically. An example implementation of stages 260, 270, 273, and 277 is described below in reference to FIG. 6.

FIG. 3 is a flowchart for an example method 300 of preparing a first dataset for efficient comparison. For each record in the first dataset, at stage 310, a computing processor 102 generates a hash value for the record from the dataset and, at stage 320, determines whether the record belongs to a partitioning group that is in spill-over. If the hash value is in a spill-over partitioning group, then at stage 325, the processor 102 adds an entry corresponding to the record to a spill-over data structure. Otherwise, at stage 330, the processor 102 adds an entry corresponding to the record to a hash index in memory. At stage 340, the processor 102 determines whether the hash index requires more than a threshold amount of memory. If the hash index requires more than the threshold amount of memory, then at stage 350 the processor 102 adds a partitioning group to the spill-over groups and at stage 360 moves any entries in the hash index that are in the added partitioning group to the spill-over data structure. In some implementations, the processor 102 repeats stages 340, 350, and 360 until stage 340 determines that the hash index does not require more than the threshold amount of memory. At stage 370, the processor 102 determines whether there are more records in the dataset. If there are more records to process, the method 300 returns to stage 310 for another record. Otherwise, at stage 380, the processor 102 begins to transition to a probe phase as described below in reference to FIG. 5 and FIG. 6. The method 300 is presented as beginning with stage 310 with the expectation that the build input would not be an empty dataset; however, some implementations may begin with the processor 102 confirming that the dataset is not empty. For example, some implementations of the method 300 may begin at stage 370, with the processor 102 determining that there are records in the dataset.

Referring to FIG. 3 in more detail, starting with stage 310, a processor 102 generates a hash value for a record from a dataset. The processor 102 identifies a record in the dataset and one or more elements of the identified record that will be used to match the record to other records. The combination of these elements of the identified record form a match value for the record. In some implementations, the processor 102 uses a query, e.g., a SQL query, to select the elements and form the match value for each record. In some implementations, the processor 102 parses a record, or record element, to identify a component of the match value for a record. In some implementations, the elements to use in the match value are identified in a join operation request. The processor 102 generates a hash value from the match value for the record using a deterministic hashing function such as a variation of MurmurHash, SipHash, DJB2, MD5, SHA, or Pearson hashing. The hashing function takes a variable input and generates a hash value (also called a “digest”). In some implementations, the processor 102 uses a hardware implementation of the hashing function to generate the hash value.

At stage 320, the processor 102 determines whether the record belongs to a partitioning group that is in spill-over. As described in more detail below, when the computing system 101 cannot hold a hash index for the entire dataset within a memory allocation, the processor 102 represents a portion of the dataset in a separate spill-over data structure instead of the hash index. The processor 102 determines whether a record is to be represented in the hash index, or in the spill-over data structure, based on whether the record belongs to a partitioning group designated for inclusion in the hash index or designated for spill-over.

Whether a record is in a particular partitioning group is defined by a partitioning function that divides the dataset into a plurality of partitioning groups. In some implementations, the partitioning groups are each roughly the same size (i.e., they will each have about the same number of member records from the dataset). In some implementations, the partitioning function operates on one or more of the values in a record. In some implementations, the partitioning function operates on the hash value (“digest”) generated at stage 310. One example of a partitioning function is to divide a digest space into N groups, e.g., by evaluating the hash value modulo N. Another example of a partitioning function is to split the digest space into N contiguous blocks of digest values, e.g., 0 . . . D₁, D₁+1 . . . D₂, D₂+1 . . . D₃, . . . , D_{N-1}+1 . . . D_{N}. In some implementations, the N contiguous blocks are the same size. In some implementations, the N contiguous blocks are sized proportionally to an expected number of records each block will receive, e.g., for the type of data in the build input. In some implementations, the partitioning function is a map of records to groups. Any consistent partitioning function may be used.

In some implementations, the processor 102 maintains a list or set of partitioning groups that are included in a hash index. In some implementations, the processor 102 maintains a list or set of partitioning groups that are excluded from a hash index. As the method 300 progresses, the processor 102 may designate additional partitioning groups for spill-over. In some implementations, the method 300 begins with no partitioning groups initially designated for spill-over. That is, the method 300 may begin with no spill-over groups in an attempt to build the hash index entirely in fast-access memory. In some implementations, the method 300 begins with one or more pre-selected partitioning groups initially designated for spill-over. At stage 320, the processor 102 determines whether a record belongs to a partitioning group that is in spill-over and, if so, then at stage 325, the processor 102 adds an entry corresponding to the record to a spill-over data structure.

At stage 325, the processor 102 adds an entry corresponding to the record to a spill-over data structure. In some implementations, the computing system 101 holds the hash index in a memory (e.g., main memory 106) that has a faster access speed than a comparatively slower memory (e.g., data storage 109 or a network-based storage), and holds the spill-over data structure in the slower memory. In some implementations, a distinct data structure is used for each partitioning group. For example, in some implementations, the processor 102 appends spill-over records to the end of a file designated for the corresponding partitioning group. In some implementations, the spill-over data structure has internal divisions for each of the partitioning groups. For example, in some implementations, the processor 102 inserts spill-over records into a file at a location designated for the corresponding partitioning group. In some implementations, the processor 102 writes spill-over records to one or more files in a delimited text format (e.g., space or tab delimited). In some implementations, the processor 102 writes spill-over records to one or more files in an internally structured format such as the eXtensible Markup Language (“XML”). In some implementations, the spill-over data structure is the same type of data structure as the hash index. In some implementations, the spill-over data structure is a tree. In some implementations, the spill-over data structure is a map. In some implementations, the spill-over data structure is a database table. The processor 102 then proceeds to stage 370 to determine if there are more records to be processed from the dataset.

At stage 330, if the record does not belong to a partitioning group that is in spill-over, the processor 102 adds an entry corresponding to the record to a hash index in memory (e.g., main memory 106). In some implementations, the entry includes a copy of the record data. In some implementations, the entry includes a portion of the record data (e.g., one or more values from the record). In some implementations, the entry includes location information referring to the record (e.g., a memory address, a table name, a row identifier, an index value, etc). In some implementations, the entry includes the match values used to generate the hash value at stage 310.

At stage 340, the processor 102 determines whether the hash index requires more than a threshold amount of memory. In some implementations, the amount of memory that will be required to hold the hash index is initially unknown. For example, if the processor 102 begins building the hash index while the dataset is being identified (e.g., in a separate query process), then the processor 102 might not have enough information to know how many records will be in the dataset or how much memory will be needed. In some implementations, the processor 102 allocates all available memory for the hash index. In some implementations, the processor 102 allocates a fixed amount or percentage of memory for the hash index. In some implementations, the amount of memory allocated may be determined externally, e.g., an operating system, a database management system (“DBMS”), a DBMS resource allocation system, or the like may control memory allocation based on outside factors such as total system utilization or account authorizations. Adding an entry at stage 330 may cause the processor 102 to exceed a threshold amount of the allocated memory. The threshold may be a fixed number of entries, a fixed amount of memory, a percentage of allocated memory, or some other metric of memory utilization. In some implementations, the threshold is less than the maximum available or allocated memory. In some implementations, the processor 102 determines that the hash index exceeds a threshold amount of memory when the amount of unused memory is reduced below a threshold value. In some implementations, the processor 102 determines whether adding the entry at stage 330 would exceed the threshold memory utilization prior to adding the entry at stage 330. In some implementations, the processor 102 determines whether the threshold memory utilization has been exceeded as a result of adding the entry at stage 330 (as depicted). In some instances, when the hash index exceeds or requires more than the threshold amount of memory, the processor 102 allocates more memory. However, the physical capacity of the memory (e.g., main memory 106) is limited and allocating additional memory for the hash index is not always an option. Accordingly, when the hash index cannot be held in memory, some portion of the index is spilled to a slower secondary memory (e.g., data storage 109, network storage, or the like).

At stage 350, responsive to determining at stage 340 that the hash index requires more memory, the processor 102 adds a partitioning group to the spill-over group. When the hash index exceeds the threshold amount of memory, the processor 102 selects one or more partition groups for spill-over. In some implementations, the selection is random. In some implementations, the selection follows a predefined sequence. In some implementations, the processor 102 identifies partition groups represented within the already-populated portion of the hash index in memory and selects a partitioning group for spill-over based on its representation. In some such implementations, the processor 102 selects the partitioning group with the most entries in the hash index, maximizing amount of memory to be recovered. In some implementations, the processor 102 selects the partitioning group with the fewest entries in the hash index, minimizing the impact on the hash index. In some implementations, the processor 102 selects multiple partition groups, e.g., selecting both the partitioning group with the most entries in the hash index and the partitioning group with the fewest entries in the hash index. In some implementations, the processor 102 selects one or more partition groups such that the number of entries in the hash index that are in the selected partitioning groups consume a target amount of memory to be recovered.

In some implementations, at stage 350, the processor 102 selects a partitioning group based on outside information such as the number of probe records that have been separately identified for a given partition group. For example, the processor 102 may expect one or more partition groups to contain a higher (or lower) number of records than other partitioning group based on information about the probe input. In some implementations, the processor 102 has pre-existing (or pre-computed) cardinality information about the probe input. In some implementations, the processor 102 obtains real-time information about the probe input. For example, referring back to FIG. 2, the method 300 is an example implementation of stage 230, which is concurrent to stage 240. In some implementations, the processor 102 determines that one or more partitions are better (or lesser) represented in the entries written to the probe-side spill-over data structures in stage 245, and the processor 102 may prioritize keeping the build-side entries for the better (or lesser) represented partitioning group in the hash index in memory. For example, it may be that a partitioning group that is under-represented in the initially processed probe input records will be over-represented in the probe input records remaining to be processed and, by keeping the build input records for the partitioning group in memory, then at stage 250, the remaining probe input records for the partitioning group will be probed at stage 253 instead of being written to the probe-side spill-over data structure at stage 257. This is just one example of possible look-ahead predictive optimizations that may be used by the processor 102 in selecting a partitioning group at stage 350, as shown in FIG. 3. In some implementations, the processor 102 uses one or more such predictive optimizations to select one or more partition groups for spill-over at stage 350.

At stage 360, the processor 102 moves any entries in the hash index that are in the new spill-over group to the spill-over data structure. In some implementations, the processor 102 copies all entries from the hash index with hash values falling within the newly selected partitioning groups (added to the spill-over group at stage 350) and writes them to the spill-over data structure used at stage 325. In some implementations, the processor 102 deletes the copied entries from the hash index in memory. Moving these entries reduces the hash index's utilization of the fast-access memory, bringing it below the threshold amount of memory.

At stage 370, the processor 102 determines whether there are more records in the dataset. In some implementations, the processor 102 receives the records of the dataset in a stream, e.g., as a result of a query, and determines at stage 370 whether the stream is complete. In some implementations, the processor 102 determines that there are no more records in the dataset if a length of time (a “timeout”) passes without receiving more records for the dataset. In some implementations, the processor 102 determines that there are no more records in the dataset based on receiving an end-of-set indicator. If there are more records to process, the method 300 returns to stage 310 for another record. Otherwise, at stage 380, the processor 102 begins to transition to a probe phase.

At stage 380, the processor 102 begins to transition to a probe phase. The transition may include an intermediary phase in which pre-processing of a probe input is completed prior to probing the build-side data structure (or structures). At stage 380, the processor 102 has finished processing the build input for construction of the in-memory hash index. As described below in reference to FIG. 5, in some implementations, the transition phase includes both pre-processing some of the probe input (specifically, probe input corresponding to partitioning groups represented in the build-side spill-over data structures) while also probing the in-memory hash index for some of the probe input (specifically, probe input corresponding to partitioning groups represented in the completed in-memory hash index).

When the processor 102 is finished building the hash index for a first dataset, e.g., using an implementation of the method 300, the hash index can then be used to compare a second dataset to the first dataset in an efficient hash join. In some implementations, while the processor 102 is building the hash index from the first dataset, the processor 102 (or another processor 102, e.g., in a multiprocessor computing system 101) pre-processes the second dataset to build a corresponding probe-side spill-over data structure (or data structures). The probe-side data structures mirror the spill-over data structures described above. As described in more detail below, entries in the probe-side data structure correspond to records from the second dataset divided into partitions using the same partitioning function operating on probe-side match values. Because these partitions match the partitions of the build-side spill-over data structure, later comparisons need only be conducted across data structures representing the same partition.

A result of the method 300 is a hash index in a fast memory and a spill-over data structure (or, in some implementations, multiple discrete structures) in a second memory, comparable to or slower than the fast memory. The hash index represents a portion of the first dataset corresponding to one or more partitioning groups and the spill-over data structure (or structures) represents the remainder of the first dataset corresponding to the partitioning groups designated for spill over. In some implementations, multiple data structures are used for the spill over data, e.g., one data structure for each partitioning group. The hash index and the spill-over data structure(s) allow for a highly efficient comparison to a second dataset.

FIG. 4 is a flowchart for an example method 400 of preparing a second dataset for efficient comparison to the first dataset. In broad overview, at stage 410, a processor 102 verifies that a hash index is still under construction for a first dataset (e.g., as described in reference to FIG. 3). While the hash index is still under construction, at stage 420, the processor 102 generates a hash value for a record from a second dataset and, at stage 430, identifies a partitioning group for the record. At stage 450, the processor 102 adds an entry corresponding to the record to a probe-side spill-over data structure for the identified partitioning group. At stage 470, the processor 102 determines whether there are more records in the second dataset. If there are more records to process, the method 400 returns to stage 410 to check the status of the build phase and proceed with another record. Otherwise, at stage 480, the processor 102 proceeds to a probe phase described below in reference to FIG. 6. The method 400 is presented as beginning with stage 410 with the expectation that the probe input would not be an empty dataset; however, some implementations may begin with the processor 102 confirming that the dataset is not empty. For example, some implementations of the method 400 may begin at stage 470, with the processor 102 determining that there are records in the second dataset.

Referring to FIG. 4 in more detail, at stage 410, a processor 102 determines whether a hash index is still under construction for a first dataset. This determination checks whether the hash join is still in a build phase or if it has begun to transition to a probe phase. In some implementations, the determination at stage 410 is a status check on the progress of the method 300. In some implementations, the processor 102 identifies whether construction of the hash index is complete. In some implementations, an interrupt causes the processor 102 to terminate the method 400. In some implementations, the determination at stage 410 is implicit. In some implementations, the processor 102 uses a state identifier, flag, or Boolean value to track whether the join is in a build phase or probe phase, and only checks whether the state identifier, flag, or Boolean value needs to be updated when it indicates that the join is in the build phase. In some implementations, the method 400 terminates when the method 300 finishes.

At stage 420, while the hash index is still under construction from the first dataset and while there are records in the second dataset, the processor 102 generates a hash value for a record from the second dataset. The processor 102 generates the hash value from a match value for the record using a deterministic hashing function such as a variation of MurmurHash, SipHash, DJB2, MD5, SHA, or Pearson hashing. In particular, the processor 102 uses the same deterministic hashing used to generate the hash values for the first dataset such that a match value in the second dataset (the probe input) is hashed to same hash value as a corresponding match value in the first dataset (the build input). In some implementations, the source information for the match value in the probe input is structured differently from the source information for the match value in the build input; however, the match values (or aggregates) for records that are to be matched together in the join should be the same such that the resulting hash values will be same.

At stage 430, the processor 102 identifies a partitioning group for the record. Whether a record is in a particular partitioning group is defined by a partitioning function that divides the dataset into a plurality of partitioning groups. The partitioning function used at stage 430 is the same partitioning used for spill-over while building the hash index, e.g., at stages 320 and 325 in the method 300 described above.

At stage 450, the processor 102 adds an entry corresponding to the record to a probe-side spill-over data structure for the identified partitioning group. In some implementations, a distinct data structure is used for each partitioning group. In some implementations, the probe-side data structure has internal divisions for each of the partitioning groups. In some implementations, the probe-side data structure is similar to the spill-over data structure described above in reference to FIG. 2. In some implementations, the probe-side data structure is the same type of data structure as the spill-over data structure. In some implementations, the two data structures use the same format. In some implementations, the probe data structure is entirely separate from the build spill-over data structure. In some implementations, the two data structures are kept on separate data storage devices. In some implementations, the probe-side data structure is a tree. In some implementations, the probe-side data structure is a map. In some implementations, the probe-side data structure is a database table.

At stage 470, the processor 102 determines whether there are more records in the second dataset. If there are more records to process, the method 400 returns to stage 410 to check the status of the build phase and proceed with another record. In some implementations, the processor 102 receives the records of the dataset in a stream, e.g., as a result of a query, and determines at stage 470 whether the stream is complete. In some implementations, the processor 102 determines that there are no more records in the second dataset if a length of time (a “timeout”) passes without receiving more records for the dataset. In some implementations, the processor 102 determines that there are no more records in the dataset based on receiving an end-of-set indicator. If there are more records to process, the method 400 returns to stage 410 for another record. Otherwise, at stage 480, the processor 102 begins to transition to a probe phase.

In some implementations, the processor 102 does not determine whether there are more records in the second dataset and, instead, simply waits for more records (if there are any) and/or completion of the build index. The method 400 is a pre-processing phase that runs in parallel with the build phase described in method 300. When the sizes of (or number of records in) each of the two datasets is known at the start, the smaller dataset is used as the first dataset (the build input) and the larger is used as the second dataset (the probe input). In such instances, it is reasonable for the method 300 to complete construction of the hash index from the first dataset before the method 400 exhausts the records in the second dataset. When the method 300 completes, then at stage 410 the processor 102 detects that the hash index is not still under construction and proceeds to stage 480 to transition to the probe phase.

At stage 480, the processor 102 begins to transition to a probe phase. The transition may include an intermediary phase in which pre-processing of a probe input is completed prior to probing the build-side data structure (or structures). At stage 480, the processor 102 has: (i) determined that processing the build input for construction of the in-memory hash index has completed, (ii) finished pre-processing the probe input (i.e., it has exhausted the second dataset), or (iii) the processor(s) 102 have finished building the hash index and build-side spill-over data structure(s) from the build input and finished building the probe-side spill-over data structure(s) from the probe input. As described below in reference to FIG. 5, in some implementations, the transition phase includes pre-processing some of the probe input (specifically, probe input corresponding to partitioning groups represented in the build-side spill-over data structures) while also probing the in-memory hash index for some of the probe input (specifically, probe input corresponding to partitioning groups represented in the completed in-memory hash index).

FIG. 5 is a flowchart for an example method 500 of transitioning from a build phase to a probe phase. In brief overview of the method 500, at stage 510, a processor 102 determines that the build phase is complete and that there are more records to process in the probe input (i.e., the second dataset). In some implementations, the determination at stage 510 is a determination that method 300 has completed prior to method 400 completing. If there are no more records in the probe input to process, in some implementations, the processor 102 may skip the method 500. At stage 520, the processor 102 generates a hash value for a record from the probe input and, at stage 530, identifies a partitioning group for the record. At stage 540, the processor 102 determines whether the hash index in memory represents build input records from the identified partitioning group. At stage 550, if the hash index in memory does not represent build input records from the identified partitioning group, then the processor 102 adds an entry for the record to the probe-side spill-over data structure for the identified partitioning group. Otherwise, if the hash index in memory does represent build input records from the identified partitioning group, then at stage 560 the processor 102 seeks, in the in-memory hash index, for an entry corresponding to the record and, at stage 570, updates a result set with the results of the seeking. At stage 580, the processor 102 determines whether there are more records in the probe input to process. If there are more records, then the method 500 returns to stage 520 to process another record. Otherwise, at stage 590, the processor 102 completes the transition to the probe phase. In some implementations, the probe phase proceeds as described below in reference to FIG. 6.

Referring to FIG. 5 in more detail, at stage 510, a processor 102 determines that the build phase is complete and that there are more records to process in the probe input (i.e., the second dataset). In some implementations, the determination at stage 510 is a determination that method 300 has completed prior to method 400 completing. If there are no more records in the probe input to process, in some implementations, the processor 102 may skip the method 500. In some implementations, the determination at stage 510 is implicit. For example, the method 500 may be implemented with the condition precedent that the hash index is complete.

At stage 520, the processor 102 generates a hash value for a record from the probe input and, at stage 530, identifies a partitioning group for the record. Stages 520 and 530 are similar to stages 420 and 430 described above in reference to FIG. 4. At stage 520, the processor 102 generates the hash value from a match value for the record using a deterministic hashing function such as a variation of MurmurHash, SipHash, DJB2, MD5, SHA, or Pearson hashing. In particular, the processor 102 uses the same deterministic hashing used to generate the hash values for the first dataset such that a match value in the second dataset (the probe input) is hashed to same hash value as a corresponding match value in the first dataset (the build input). At stage 530, the processor 102 identifies a partitioning group for the record. Whether a record is in a particular partitioning group is defined by the partitioning function that divides the dataset into a plurality of partitioning groups. The partitioning function used at stage 530 is the same partitioning used in stage 430.

At stage 540, the processor 102 determines whether the hash index in memory represents build input records from the identified partitioning group. Similar to stage 320, the processor 102 determines whether the identified partitioning group is a spill-over group. If the identified partitioning group is a spill-over group, then the hash index in memory does not represent build input records from the identified partitioning group. Otherwise, the hash index in memory may represent build input records from the identified partitioning group. In some implementations, the processor 102 maintains statistics or counts of entries for the partitioning groups and uses the maintained statistics to determine whether the hash index in memory represents any build input records from the identified partitioning group.

At stage 550, if the hash index in memory does not represent build input records from the identified partitioning group, then the processor 102 adds an entry for the record to the probe-side spill-over data structure for the identified partitioning group. Stage 550 is similar to stage 450 described above in reference to FIG. 4. The processor 102 continues to build out the probe-side spill-over data structure (or data structures) in the same manner described in reference to FIG. 4.

At stage 560, if the hash index in memory does represent build input records from the identified partitioning group, the processor 102 seeks, in the in-memory hash index, for an entry corresponding to the record and, at stage 570, updates a result set with the results of the seeking. The processor 102 identifies one or more entries in the hash index with the same hash value as the hash value generated at stage 520 and determines whether any of the one or more entries corresponds to the record from the second dataset. Because hash functions have a limited digest space, it is possible for entries to share the same hash value without representing a proper match. In some implementations, the processor 102 resolves possible hash collisions by comparing one or more secondary values after identifying entries having a shared same hash value. For examples, in some implementations, the processor 102 first identifies entries with the same hash value and then eliminates entries from the match unless they also have the same match values used to generate the shared hash value. In some implementations, seeking an entry from an in-memory index can be performed in constant time. A hash index is structured such that the hash value corresponds to a specific address within the hash index. The processor 102 converts the hash value to the specific address and directly accessing the memory contents for the index. In some implementations, the memory contents contain an entry corresponding to the hash value. In some implementations, the memory contents contain additional memory addressing data for an entry corresponding to the hash value. For example, multiple entries with the same hash value may be represented in the hash index using a linked list with an initial entry of the linked list stored at (or referenced by) the memory corresponding to the hash value. Other collision resolution strategies may be used as well, e.g., cuckoo hashing. Because the hash index is designed for efficient lookup by hash value, e.g., a constant time lookup, the seek at stage 560 is extremely efficient.

At stage 570, the processor 102 updates a result set with results of the seeking from stage 560. In some implementations, the result set is a collection of entries each representing a union of values from respective records in the probe input and records in the build input that matched at stage 560. In some implementations, the result set is a copy of records from one dataset that matched to the other dataset. For example, in some implementations, the result set is a collection of records from the probe input for which matching entries were identified in the build input.

At stage 580, the processor 102 determines whether there are more records in the probe input to process. If there are more records, then the method 500 returns to stage 520 to process another record. Otherwise, at stage 590, the processor 102 completes the transition to the probe phase. In some implementations, the probe phase proceeds as described below in reference to FIG. 6.

A processor 102 implementing the methods 400 and 500 creates a probe-side spill-over data structure (or, in some implementations, multiple discrete data structures). In some implementations, the data structures are stored in a memory or data storage device (e.g., data storage 109 or network-based storage). In some implementations, a probe-side data structure groups together entries that are collectively in the same partitioning group. Records from the first dataset that will match to records from the second dataset will fall in the same partitioning group. Accordingly, the probe phase of the hash join compares entries by partitioning group. Each partitioning group can be compared in parallel with the others. In some implementations, the processor 102 compares the build-side spill-over data structure and the probe-side spill-over data structure for a partitioning group by executing a join, e.g., a hash join, on the two data structures. In some implementations, the processor 102 completes the hash join using the hash index in memory and merges the result set with results obtained by joining the build-side and probe-side spill-over data structures. FIG. 6, described in detail below, is a flowchart for an example method 600 of comparing the two datasets.

FIG. 6 is a flowchart for an example method 600 of comparing a second dataset to the first dataset. In brief overview of the method 600, at stage 610, a processor 102 determines that the build phase is complete for both the build input and the probe input (i.e., the first and second datasets). At stage 620, the processor 102 selects a partitioning group for probing. In some implementations, the processor 102 prioritizes selecting partitioning groups represented by the hash index in memory, thereby probing the hash index in memory before loading build-side spill-over data into memory. At stage 630, the processor 102 determines whether the index in memory represents entries for the selected partitioning group. If not, then at stage 635, the processor 102 loads an index of the partitioning group into memory. At stage 640, the processor 102 determines whether there are entries remaining in the probe-side spill-over data structure for the selected partitioning group and, if not, determines, at stage 680, whether there are more partitioning groups to process. If, at stage 640, there are entries remaining in the probe-side spill-over data structure, then at stage 650, the processor 102 identifies a probe entry from the probe-side spill-over data structure and, at stage 660, seeks a corresponding entry from the in-memory index. At stage 670, the processor 102 updates a result set based on the seeking. At stage 680, the processor 102 determines whether there are more partitioning groups to process. If there are more partitioning groups to process, the method 600 return to stage 620. If not, then at stage 690 the processor 102 returns the result set.

Referring to FIG. 6 in more detail, at stage 610, a processor 102 determines that the build phase is complete for both the build input and the probe input (i.e., the first and second datasets). In some implementations, the determination at stage 610 is a determination that method 300 and 400 have completed. In some implementations, the determination at stage 610 is a determination that method 300, 400, and 500 have completed. In some implementations, the determination at stage 610 is implicit. For example, the method 600 may be implemented with the condition precedent that the hash index is complete and that the probe input is properly positioned for the probe phase.

At stage 620, the processor 102 selects a partitioning group for probing. In some implementations, the processor 102 prioritizes selecting partitioning groups represented by the hash index in memory. In some serialized implementations, the processor 102 selects partitioning groups represented in the hash index before selecting partitioning groups represented in the build-side spill-over data structure. Referring back to FIG. 2, by prioritizing the partitioning groups represented by the hash index, the processor 102 effects stage 260 prior to stage 270. In FIG. 6, in the method 600, at stage 630, the processor 102 determines whether the index in memory represents entries for the selected partitioning group. If not, then at stage 635, the processor 102 loads an index of the partitioning group into memory. When the processor 102 does select a partitioning group represented in the build-side spill-over data structure, the processor 102 may need to clear the hash index from memory in order to load the spill-over data; accordingly, such implementations avoid clearing the hash index until all represented partitioning groups are processed and the data in memory is no longer needed for the join. In some implementations, the processor 102 distributes spill-over data from the spill-over data structures to additional computing resources for parallel processing.

At stage 630, the processor 102 determines whether the index in memory represents entries for the selected partitioning group. If the in-memory hash index represents the selected partitioning group, the processor 102 can probe the in-memory hash index. If not, then at stage 635, the processor 102 loads an index of the partitioning group into memory for probing. In some implementations, the processor 102 reads the spill-over data structure from storage and generates a hash index in memory for the read data. In some implementations, the processor 102 compares the sizes of the build-side spill-over data structure and the probe-side spill-over data structure for the selected partitioning group. If the build-side spill-over data structure for the partitioning group is larger than the probe-side spill-over data structure for the partitioning group, then, in some implementations, the processor 102 swaps the two data structures and at stage 635 loads the probe-side data structure into memory as a searchable index and uses the corresponding build-side data structure to probe the searchable index.

In some implementations, the spill-over data structure cannot be fully read into memory at stage 635. Instead, the processor 102 further partitions the over-sized data structure into multiple sub-partitions and loads only the sub-partitions that can be represented in the available memory. These sub-partitions are then treated as a partitioning group, and the remaining sub-partitions as another partitioning group. In some implementations, the partitioning function divides the input data into partitioning groups tailored to minimize the likelihood of an over-sized partitioning group. For example, in some implementations, the partitioning function divides the input data into a large number of partitioning groups.

In some implementations, the processor 102 performs a join on the spill-over data structures in storage, effectively re-partitioning them to manage memory recursively. In such implementations, when the processor 102 determines at stage 630 that the index in memory does not represent entries for the selected partitioning group, the processor 102 calls or invokes a join for the partitioning group (joining the build-side spill-over data structure and the probe-side spill-over data structure for the partitioning group) and merges the result of the join with the results at stage 690. In some such implementations, the join is a hash join such as described herein.

At stage 640, the processor 102 determines whether there are entries remaining in the probe-side spill-over data structure for the selected partitioning group. If not, then at stage 680, the processor 102 determines whether there are more partitioning groups to process. When all partitioning groups have been processed, then at stage 690 the processor 102 returns the result set.

At stage 650, if there are entries remaining in the probe-side spill-over data structure as determined at stage 640, then the processor 102 identifies a probe entry from the probe-side spill-over data structure. In some implementations, the next probe entry is the next line in a file. In some implementations, the next probe entry is the next delimited block of data in a file. In some implementations, the next probe entry is a row from a database.

At stage 660, the processor 102 seeks an entry from the in-memory index corresponding to the identified entry from the probe-side spill-over data structure. At stage 660, the processor 102 uses the hash index to match the identified entry from the probe-side spill-over data structure to an entry from the in-memory index based on the hash value. The processor 102 identifies one or more entries in the hash index with the same hash value as the probe entry's hash value and determines whether any of the one or more entries corresponds to the probe entry (or to the record represented by the probe entry). Because hash functions have a limited digest space, it is possible for entries to share the same hash value without representing a proper match. In some implementations, the processor 102 resolves possible hash collisions by comparing one or more secondary values after identifying entries having a shared same hash value. For examples, in some implementations, the processor 102 first identifies entries with the same hash value and then eliminates entries from the match unless they also have the same match values used to generate the shared hash value. Because the hash index is designed for efficient lookup by hash value, e.g., a constant time lookup, the seek at stage 660 is extremely efficient. At stage 670, the processor 102 updates a result set based on the seeking. Stages 660 and 670 are similar to stages 560 and 570 described above in reference to FIG. 5.

At stage 680, the processor 102 determines whether there are more partitioning groups to process. If there are more partitioning groups to process, the method 600 return to stage 620. Otherwise, at stage 690, the processor 102 returns the result set. In some implementations, the processor 102 merges result sets from parallel processing of the spill-over data structures. In some implementations, the processor 102 writes the result set to a storage location. In some implementations, the processor 102 transmits the result set via a data network, e.g., using a data transmission or streaming protocol.

In at least one aspect, the above descriptions may be used to implement a method of processing a join instruction on a first dataset and a second dataset, the method including processing the first dataset by a computing system comprising one or more processors with access to a first memory and with access to a second memory, using a partitioning function that deterministically partitions records into respective ones of a plurality of groups. The computing system processes the first dataset by building, in the first memory, a hash index representative of the first dataset using a first subset of records from the first dataset; determining that the hash index utilizes a threshold allocation of the first memory and, in response, moving records fitting into a first group defined by the partitioning function from the hash index in the first memory to a data structure in the second memory; adding entries to the hash index in the first memory using a second subset of records from the first dataset, the second subset of records fitting into a second group defined by the partitioning function, wherein the second subset of records excludes a third subset of records from the first dataset fitting into the first group defined by the partitioning function; and recording, in the data structure in the second memory, the third subset of records from the first dataset. The method further includes processing, by the computing system in parallel with processing the first dataset, a first portion of the second dataset by recording, in the second memory, records from the first portion of the second dataset partitioned by the computing system into a plurality of groups in accordance with the partitioning function. The method further includes determining, by the computing system, that all records of the first dataset are represented in one of either the hash index or the data structure, and in response, (i) probing the hash index for records matching records in a second portion of the second dataset fitting into the second group defined by the partitioning function and (ii) probing the data structure for records matching records in the second dataset fitting into the first group defined by the partitioning function. In some implementations, the second memory has a slower access time than the first memory. Some implementations of the method include probing the hash index and the data structure in parallel. In some implementations, the partitioning function partitions records based on respective hash values.

Some implementations of the method of processing the join instruction include probing the data structure, by the computing system, using records recorded in the second memory from the first portion of the second dataset.

Some implementations of the method of processing the join instruction include recording, in the second memory, records from the second portion of the second dataset fitting into the first group defined by the partitioning function while probing the hash index for records matching records in the second portion of the second dataset fitting into the second group defined by the partitioning function.

Some implementations of the method of processing the join instruction include probing the data structure for records matching records in the first portion of the second dataset fitting into the first group defined by the partitioning function and probing the data structure for records matching records in the second portion of the second dataset fitting into the first group defined by the partitioning function.

Some implementations of the method of processing the join instruction include determining, while adding entries to the hash index in the first memory using the second subset of records from the first dataset, that the hash index again utilizes the threshold allocation of the first memory and, in response, moving records fitting into a third group defined by the partitioning function from the hash index in the first memory to the data structure in the second memory, wherein the second group defined by the partitioning function included the third group and a fourth group defined by the partitioning function; adding additional entries to the hash index in the first memory using a fourth subset of records from the first dataset, the fourth subset of records fitting into the fourth group defined by the partitioning function, wherein the fourth subset of records excludes a fifth subset of records from the first dataset fitting into the third group defined by the partitioning function; and recording the fifth subset of records from the first dataset in the data structure in the second memory.

The probing identifies whether there are matching records present. For example, some implementations of the method include returning, by the computing system, a result set identifying records from the first dataset matching records from the second dataset based on the probing.

The methods described may be implemented in computer systems. For example, an implementation of a database management system (“DBMS”) may provide a hash join operation implementing a join as described. In some implementations of a computer system providing a hash join, a multi-core processor allocates different cores to the different parallel tasks described. In some implementations, multiple processors work in concert. The described hash join provides significant opportunities for parallelism that result in significant improvement over previous implementations of join operations.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs embodied on a tangible medium, i.e., one or more modules of computer program instructions, encoded on one or more computer storage media for execution by, or to control the operation of, a data processing apparatus (including, e.g., a processor 102). A computer storage medium can be, or be included in, a computer-readable storage device, a computer-readable storage substrate, a random or serial access memory array or device, or a combination of one or more of them. The computer storage medium can also be, or be included in, one or more separate components or media (e.g., multiple CDs, disks, or other storage devices). The computer storage medium is tangible. The computer storage medium stores data, e.g., computer-executable instructions, in a non-transitory form.

A computer program (also known as a program, software, software application, script, or code) can be written in any form of programming language, including compiled languages, interpreted languages, declarative languages, and procedural languages, and the computer program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, libraries, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a field programmable gate array (“FPGA”) or an application specific integrated circuit (“ASIC”). Such a special purpose circuit may be referred to as a computer processor even if it is not a general-purpose processor.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

References to “or” may be construed as inclusive so that any terms described using “or” may indicate any of a single, more than one, and all of the described terms. The labels “first,” “second,” “third,” and so forth are not necessarily meant to indicate an ordering and are generally used merely to distinguish between like or similar items or elements.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be used.

What is claimed is:

1. A method of processing a join instruction on a first dataset and a second dataset, the method comprising:
processing the first dataset by a computing system comprising one or more processors with access to a first memory and with access to a second memory, using a partitioning function that deterministically partitions records into respective ones of a plurality of groups, by:
building, in the first memory, a hash index representative of the first dataset using a first subset of records from the first dataset;
determining that the hash index utilizes a threshold allocation of the first memory and, in response, moving records fitting into a first group defined by the partitioning function from the hash index in the first memory to a data structure in the second memory;
adding entries to the hash index in the first memory using a second subset of records from the first dataset, the second subset of records fitting into a second group defined by the partitioning function, wherein the second subset of records excludes a third subset of records from the first dataset fitting into the first group defined by the partitioning function; and
recording, in the data structure in the second memory, the third subset of records from the first dataset;
processing, by the computing system in parallel with processing the first dataset, a first portion of the second dataset by:
recording, in the second memory, records from the first portion of the second dataset partitioned by the computing system into a plurality of groups in accordance with the partitioning function; and
determining, by the computing system, that all records of the first dataset are represented in one of either the hash index or the data structure, and in response, (i) probing the hash index for records matching records in a second portion of the second dataset fitting into the second group defined by the partitioning function and (ii) identifying records in the data structure matching records in the second dataset fitting into the first group defined by the partitioning function.

2. The method of claim 1, wherein the second memory has a slower access time than the first memory.

3. The method of claim 1, comprising (i) probing the hash index and (ii) identifying records in the data structure, by the computing system, in parallel.

4. The method of claim 1, comprising probing the data structure, by the computing system, using records recorded in the second memory from the first portion of the second dataset.

5. The method of claim 1, comprising recording, in the second memory, records from the second portion of the second dataset fitting into the first group defined by the partitioning function while probing the hash index for records matching records in the second portion of the second dataset fitting into the second group defined by the partitioning function.

6. The method of claim 1, comprising probing the data structure for records matching records in the first portion of the second dataset fitting into the first group defined by the partitioning function and probing the data structure for records matching records in the second portion of the second dataset fitting into the first group defined by the partitioning function.

7. The method of claim 1, comprising
determining, while adding entries to the hash index in the first memory using the second subset of records from the first dataset, that the hash index again utilizes the threshold allocation of the first memory and, in response, moving records fitting into a third group defined by the partitioning function from the hash index in the first memory to the data structure in the second memory, wherein the second group defined by the partitioning function included the third group and a fourth group defined by the partitioning function;
adding additional entries to the hash index in the first memory using a fourth subset of records from the first dataset, the fourth subset of records fitting into the fourth group defined by the partitioning function, wherein the fourth subset of records excludes a fifth subset of records from the first dataset fitting into the third group defined by the partitioning function; and
recording, in the data structure in the second memory, the fifth subset of records from the first dataset.

8. The method of claim 1, wherein the partitioning function partitions records based on respective hash values.

9. The method of claim 1, comprising returning, by the computing system, a result set identifying records from the first dataset matching records from the second dataset based on the probing.

10. A system comprising one or more processors each with access to a first memory and with access to a second memory, the one or more processors configured to:
processes a first dataset, using a partitioning function that deterministically partitions records into respective ones of a plurality of groups, by:
building, in the first memory, a hash index representative of the first dataset using a first subset of records from the first dataset;
determining that the hash index utilizes a threshold allocation of the first memory and, in response, moving records fitting into a first group defined by the partitioning function from the hash index in the first memory to a data structure in the second memory;
adding entries to the hash index in the first memory using a second subset of records from the first dataset, the second subset of records fitting into a second group defined by the partitioning function, wherein the second subset of records excludes a third subset of records from the first dataset fitting into the first group defined by the partitioning function; and
recording, in the data structure in the second memory, the third subset of records from the first dataset;
process a first portion of a second dataset in parallel with processing the first dataset by recording, in the second memory, records from the first portion of the second dataset partitioned by the computing system into a plurality of groups in accordance with the partitioning function; and
determine when all records of the first dataset are represented in one of either the hash index or the data structure, and in response, (i) probe the hash index for records matching records in a second portion of the second dataset fitting into the second group defined by the partitioning function and (ii) identify records in the data structure matching records in the second dataset fitting into the first group defined by the partitioning function.

11. The system of claim 10, wherein the second memory has a slower access time than the first memory.

12. The system of claim 10, wherein the computing system is configured to (i) probe the hash index and (ii) identify records in the data structure in parallel.

13. The system of claim 10, wherein the computing system is configured to identify records in the data structure using records recorded in the second memory from the first portion of the second dataset.

14. The system of claim 10, wherein the computing system is configured to probe the data structure for records matching records in the first portion of the second dataset fitting into the first group defined by the partitioning function and identify records in the data structure matching records in the second portion of the second dataset fitting into the first group defined by the partitioning function.

15. The system of claim 10, wherein the partitioning function partitions records based on respective hash values.

16. The system of claim 10, wherein the computing system is configured to return a result set identifying records from the first dataset matching records from the second dataset based on the probing.

17. A non-transitory computer-readable medium storing instructions that cause a processor executing the instructions to:
processes a first dataset, using a partitioning function that deterministically partitions records into respective ones of a plurality of groups, by:
building, in a first memory, a hash index representative of the first dataset using a first subset of records from the first dataset;
determining that the hash index utilizes a threshold allocation of the first memory and, in response, moving records fitting into a first group defined by the partitioning function from the hash index in the first memory to a data structure in a second memory;
adding entries to the hash index in the first memory using a second subset of records from the first dataset, the second subset of records fitting into a second group defined by the partitioning function, wherein the second subset of records excludes a third subset of records from the first dataset fitting into the first group defined by the partitioning function; and
recording, in the data structure in the second memory, the third subset of records from the first dataset;
process a first portion of a second dataset in parallel with processing the first dataset by recording, in the second memory, records from the first portion of the second dataset partitioned by the computing system into a plurality of groups in accordance with the partitioning function; and
determine when all records of the first dataset are represented in one of either the hash index or the data structure, and in response, (i) probe the hash index for records matching records in a second portion of the second dataset fitting into the second group defined by the partitioning function and (ii) identify records in the data structure matching records in the second dataset fitting into the first group defined by the partitioning function.

18. The non-transitory computer-readable medium of claim 17, further storing instructions that cause the processor executing the instructions to (i) probe the hash index and (ii) identify records in the data structure in parallel.

19. The non-transitory computer-readable medium of claim 17, wherein the partitioning function partitions records based on respective hash values.

20. The non-transitory computer-readable medium of claim 17, further storing instructions that cause the processor executing the instructions to return a result set identifying records from the first dataset matching records from the second dataset based on the probing.
